(19) United States
(12) Patent Application Publication
(10) Pub. No.: US 2024/0286766 A1
(43) Pub. Date: Aug. 29, 2024

(54) SELF ALIGNING SYSTEM

(71) Applicants: AIRBUS OPERATIONS LIMITED, Bristol (GB); THE MANUFACTURING TECHNOLOGY CENTRE LIMITED, West Midlands (GB)

(72) Inventors: Ian MOORE, Bristol (GB); Dan EDWARDS, Flintshire (GB)

(21) Appl. No.: 18/585,746

(22) Filed: Feb. 23, 2024

(30) Foreign Application Priority Data
Feb. 24, 2023 (GB) 2302718.8

(51) Int. Cl. B64F 5/50; B23B 35/00; G05D 3/12

(52) U.S. Cl. CPC B64F 5/50; B23B 35/00; G05D 3/12

(57) ABSTRACT

An automated self-aligning system is disclosed including a first robot arm attached to a clamping end effector including clamp jaws for clamping either side of a workpiece and with an aperture in one of the clamp jaws. A second robot arm is attached to a tooling end effector including a tool module carrying a tool. The tool module is insertable into the aperture and the tool is adapted to perform an operation on the workpiece. The second robot arm is arranged to move the tool module so as to move the tool module in a direction of insertion so as to insert the tool module into the aperture. A load sensor coupled to the tooling end effector and is arranged to determine a load in the direction of insertion of the tool module. The tooling end effector is further arranged to move the tool module with respect to the second robot arm in a plurality of degrees of freedom different than the insertion direction.

### CROSS RELATED APPLICATION

This application claims priority to United Kingdom Patent Application GB 2302718.8, filed Feb. 24, 2023, the entire contents of which is hereby incorporated by reference.

### FIELD OF THE INVENTION

The present invention relates to an automated self-aligning system and a method of automatically aligning a tool module carried by an end effector.

### BACKGROUND OF THE INVENTION

A wing of an aircraft typically includes a torsion box comprising upper and lower aerofoil covers (or skins) on either side of a structural frame comprising spanwise spars and chordwise ribs. At least one spar is provided for each wing, although two or more is common. In an aircraft wing, the torsion box is commonly known as a wing box. The covers may be reinforced with stringers, which extend generally spanwise.

It is known to modify the wing box to create a “one way assembly” arrangement. This uses fewer components and reduces assembly time of the wing box. Known modifications include joining the rib to the spar with a rib post. The rib post has a rib post foot joined to the spar and upstanding rib post web for joining the rib to the web. The rib post may be joined to the spar prior to assembling the wing box.

It is also known to automate the manufacture and assembly of such a wing box by using two robots, as described in GB2594503. A first robot clamps around the assembly to secure components together, while a second robot drills and fastens the assembly through an opening in the clamp. This is advantageous because robots are more accurate and faster than manually drilling and fastening the components.

The opening in the clamp guides the second robot to a desired location for drilling and fastening. This ensures that the drilled hole and subsequent fastener placement is accurate, i.e., in the correct location. The second robot must therefore be able accurately locate and insert into the opening in the clamp. Otherwise, the second robot cannot complete the drilling and fastening operation and these steps must be completed manually, which removes the benefit of automating the manufacture and assembly of the wing box.

### SUMMARY OF THE INVENTION

A first aspect of the invention provides an automated self-aligning system, the system comprising a first robot arm attached to a clamping end effector including clamp jaws for clamping either side of a workpiece, and with an aperture in one of the clamp jaws; a second robot arm attached to a tooling end effector including a tool module carrying a tool, wherein the tool module is insertable into the aperture, and the tool is adapted to perform an operation on the workpiece; wherein the second robot arm is arranged to move the tool module so as to move the tool module in a direction of insertion so as to insert the tool module into the aperture; a load sensor coupled to the tooling end effector; wherein the load sensor is arranged to determine a load in the direction of insertion of the tool module; wherein the tooling end effector is further arranged to move the tool module with respect to the second robot arm in a plurality of degrees of freedom different than the insertion direction; and a control system connected to the tooling end effector, wherein the control system is arranged to cycle the tool module to move in the plurality of degrees of freedom in a predetermined sequence if the signal received from the load sensor exceeds a predetermined threshold.

A further aspect of the invention provides a method of automatically aligning a tool module carried by a tooling end effector into an aperture of a clamp jaw carried by a clamping end effector, wherein a first robot arm is attached to the clamping end effector and a second robot arm is attached to the tooling end effector, the method comprising: using the second robot arm to move the tool module so as to move the tool module along a direction of insertion to insert the tool module into the aperture; receiving a signal from a load sensor coupled to the tooling end effector that exceeds a predetermined threshold; wherein the sensor is arranged to determine a load in the direction of insertion of the tool module; cycling the tool module to move with respect to the second robot arm in a plurality of degrees of freedom in a predetermined sequence to align the tool module, wherein the tool module is cycled until the signal from the load sensor is less than the predetermined threshold, wherein moving in the plurality of degrees of freedom is different than moving in the insertion direction.

The load sensor may generate a signal when a forward end of the tool module abuts against a surface and indicates that the tool module is unable to continue moving in the direction of insertion without application of excessive force. The surface may be the clamping end effector, the clamp jaws, the workpiece or an inner surface of the aperture, or an obstruction for example. The signal from the load sensor increases when there is an increased resistance against the tool module moving in the direction of insertion. The predetermined threshold may indicate that the tool module is restricted from moving in the direction of insertion.

The direction of insertion is the direction that the second robot arm moves the tool module to insert the tool module into the aperture. The tool module is inserted into the aperture so that the tool carried by the tool module is positioned adjacent to the workpiece and able to perform an operation on the workpiece.

The direction of insertion may change depending on the relative positioning of the tooling end effector relative to the clamping effector. When a longitudinal axis of the tooling module is substantially aligned with a longitudinal axis of the aperture, the tool module may be inserted into the aperture when moved in the direction of insertion.

The invention is advantageous because the orientation and position of tool module may be automatically adjusted to align with the aperture without any manual input, thereby facilitating the automated assembly and manufacture objective.

The method and system may be used for automatically assembling a wing rib in a one-way assembly.

The longitudinal axis of the tooling end effector defines a central axis of the tooling end effector. The longitudinal axis of the aperture defines a central axis of the aperture. The tool end effector shares the same longitudinal axis with the aperture when the tool end effector is aligned with the aperture.

The predetermined sequence and/or the predetermined threshold may be determined from experimental data or may be pre-programmed into the control system. The predetermined sequence and/or predetermined threshold may be input by an operator into the control system.

The control system may move the tooling end effector sequentially through a predetermined sequence of movements in the plurality of degrees of freedom. The predetermined sequence is an order of movements in the plurality of degrees of freedom. The predetermined sequence includes at least two degrees of freedom.

Cycling the tool module involves moving the tool module sequentially through each of the plurality of degrees of freedom in the predetermined sequence. Cycling the tooling module may mimic shaking and/or rotating the tooling module in the aperture.

Optionally, the control system may be arranged to cycle the tool module to move through each of the plurality of degrees of freedom for a cycle length or until the signal received from the load sensor is less than the predetermined threshold value.

The cycle length is a period of time that the control system attempts to move the tooling end effector in one of the plurality of degrees of freedom. The cycle length may be pre-programmed into the control system.

The load sensor may be arranged to determine a load in the direction of insertion as the tool module is moved in each of the plurality of degrees of freedom. If the load detected by the load sensor does not fall below the predetermined threshold when the tooling module is moved in one of the plurality of degrees of freedom in the predetermined sequence, the control system cycles the tool module through the next degree of freedom in the predetermined sequence.

Optionally, the control system restricts the tool module from completing a movement in one of the plurality of degrees of freedom if the signal received from the load sensor exceeds the predetermined threshold.

If the load detected by the load detector does not exceed the predetermined threshold, the control system may prevent the tool module from completing a movement in one of the plurality of degrees of freedom. Completing a movement in one of the plurality of degrees of freedom may involve, for example, moving the tool module in one of the degrees of freedom for a length of time or for a set distance or rotation. The control system may proceed to move the tool module in the next of the plurality of degrees of freedom in the predetermined sequence.

Optionally, the diameter of the aperture reduces stepwise along a longitudinal length of the aperture in the direction of insertion to form multiple concentric bores.

The aperture wall may comprise at least one stepped protrusion that extends into the aperture. Reducing the diameter of the aperture along the insertion direction may enable the tool module to be more accurately positioned relative to the workpiece.

Optionally, the tool module includes a plurality of diameters, and a diameter at a forward end of the tool module is smaller than a diameter at a rearward end of the tool module.

The tool module may be substantially cylindrical. The forward end of the tool module inserts into an opening of the aperture in advance of the rearward end of the tool module. The tool module may comprise at least one stepped protrusion or outer wall. The smaller diameter of the forward end enables the tool module to insert into the aperture easily.

Optionally, the tool module comprises a least one chamfer between the diameter at the forward end of the tool module and the diameter at the rearward end of the tool module.

Optionally, the tool module may comprise an expanding collet to engage with the aperture, and preferably, the tool module comprises multiple concentric expanding collets or collet portions, wherein each expanding collet or collet portion engages with a different concentric bore diameter.

Optionally, an opening of the aperture comprises at least one chamfer.

Optionally, the tooling end effector further comprises a drive system, and wherein the drive system is arranged to move the tool module with respect to the second robot arm.

Optionally, the drive system comprises a pressure cylinder system, and preferably, wherein the pressure cylinder system is pneumatic.

The drive system may apply a pressure to the tooling end effector to move the tool module in a plurality of degrees of freedom. The drive system controls the finer movements of the tooling module. The finer movement describes movements of the tooling module relative to the global positioning of the second robot arm.

Optionally, the plurality of degrees of freedom includes at least two of: vertical translation, horizontal translation, rolling, pitching or yawing with respect to the direction of insertion.

The plurality of degrees of freedom may include any translational and/or rotational movement, or combination thereof.

Optionally, the system is further configured to align the clamping end effector relative to the tooling end effector using engageable aligning features, and optionally, wherein the engageable aligning features comprises a protrusion on one end effector that is arranged to be received in an opening of the other end effector.

The engageable aligning features may be engaged and the second robot arm may continue to move the tool module in the direction of insertion. The engageable aligning features may be any suitable component that is positioned on one robot arm and is arranged to be received by the other robot arm. For example, the engageable aligning features may include a pin and an opening arranged to receive the pin.

Optionally, wherein the first robot arm is attached to a first robot and the second robot arm is attached to a second robot, and wherein the first and second robots are mounted on a common platform.

Optionally, the tool module is one of a drilling module for carrying a drilling tool, or a fastening module for carrying a fastener.

Optionally, the workpiece is a rib web and rib post or integrated rib foot.

Optionally, cycling the tool module substantially aligns a longitudinal axis of the tool module with a longitudinal axis of the aperture so that the second robot arm may move the tool module along the direction of insertion.

Optionally, after the tool module has cycled through all of the plurality of degrees of freedom, the second robot arm attempts to move the tool module in the direction of insertion to continue inserting the tool module into the aperture.

Optionally, the tool module is arranged to cycle through each plurality of degrees of freedom for a cycle length or until the signal received from the load sensor is below the predetermined threshold.

Optionally, the tooling end effector and the clamping end effector further comprise engageable aligning features; the method further comprising moving the second robot arm to engage the engageable aligning features.

Optionally, the method further comprises moving the tool module along the direction of insertion after the engageable alignment features are engaged.

Optionally, an opening of the aperture comprises a chamfer, the method further comprising abutting the chamfer against the tool module when the tool module is moved along the direction of insertion when a longitudinal axis of the tool module is misaligned with a longitudinal axis of the aperture.

Optionally, the tool module comprises at least one chamfer, the method further comprising abutting the at least one chamfer against the aperture when the tool module is moved along the direction of insertion or when the tool module is cycled to move in the plurality of degrees of freedom when a longitudinal axis of the tool module is misaligned with a longitudinal axis of the aperture.

Optionally, the tool module is a drilling module and the method further comprises closing the clamp jaws on the workpiece and drilling a hole with the drilling module through the workpiece.

Optionally, the tool module is a fastening module, and the method further comprises installing a fastener in the hole with the fastening module to fasten the workpiece prior to removing the clamp.

Optionally, the clamp is used to clamp a rib web or rib post or integrated rib foot of an aircraft wing for automated drilling and/or fastening of the rib web to the rib post or integrated rib food.

Reference to longitudinal spar refers to a spar running along the length of the wing in a substantially spanwise direction from the wing root to the wing tip. The longitudinal spar may be substantially perpendicular to the longitudinal axis of the fuselage, although may be slightly inclined to the fuselage longitudinal axis due to, for example, the aspect ratio, twist or sweep of the wing.

Reference to terms such as upper, lower, leading edge, and trailing edge are used in reference to conventional terminology of aircraft. For example, upper cover refers to the cover on the side of the wing in which the lift component is directed.

### BRIEF DESCRIPTION OF THE DRAWINGS

Embodiments of the invention will now be described with reference to the accompanying drawings, in which:

FIG. 1 illustrates a perspective view of a fixed wing aircraft

FIG. 2 illustrates a schematic plan view of a starboard wing box and centre wing box;

FIG. 3 illustrates a partial cross sectional side view of a forward end of the wing box, showing the rib web, rib post and integrated rib feet;

FIG. 4 illustrates a partial perspective view of a wing cover with integral stringers, integrated rib feet and the rib web;

FIG. 5 illustrates a perspective view of an automated assembly system for an aircraft wing box;

FIG. 6 illustrates a partial perspective view of a tooling end effector and a clamping end effector;

FIGS. 7a and 7b illustrate cross sectional side view of a clamp jaw with an aperture;

FIGS. 8a to 8c illustrate a cross sectional side view of a tool module inserting into an aperture in a clamp jaw;

FIG. 9 schematically illustrates a self-alignment system;

FIGS. 10a to 10d illustrates a cross sectional side view of a tool module that self-aligns to insert into an aperture in a clamp jaw;

FIGS. 11a to 11d illustrates a cross sectional side view of another exemplary tool module that self-aligns to insert into an aperture in a clamp jaw;

FIG. 12 schematically illustrates a method of inserting a tool module into an aperture;

FIG. 13 schematically illustrates a plurality of degrees of freedom of a tool module;

FIG. 14 schematically illustrates a predetermined sequence of degrees of freedom;

FIG. 15 schematically illustrates a method of cycling the tool module through a plurality of degrees of freedom;

FIGS. 16a and 16b illustrates a tool module comprising an expanding collet in a retracted state and an expanded state.

### DETAILED DESCRIPTION OF EMBODIMENT(S)

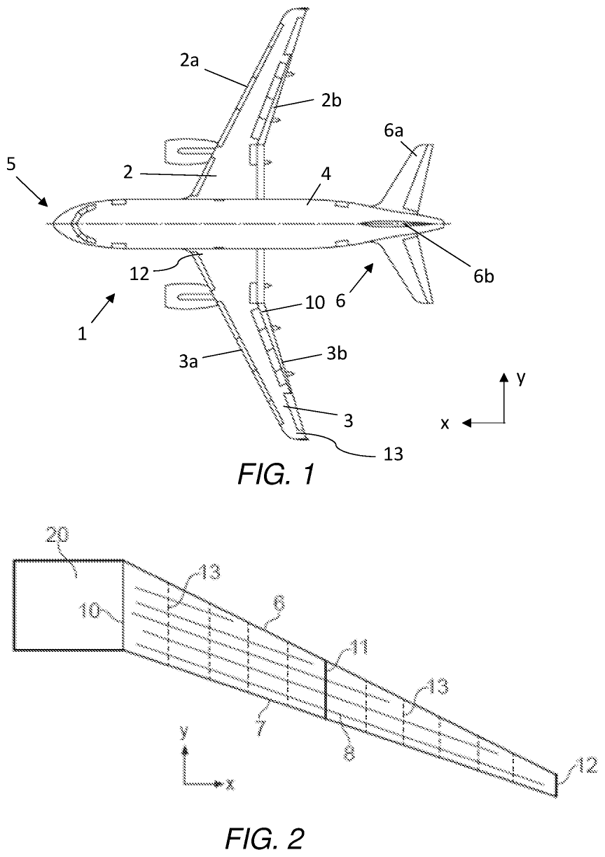

FIG. 1 illustrates a typical configuration for a fixed wing passenger transport aircraft 1. The aircraft 1 comprises port and starboard wings 2, 3 extending from a fuselage 4, engines 5, horizontal tailplane 6 and vertical tailplane 7. It will be appreciated that this invention is applicable to a wide variety of aircraft types not just that illustrated in FIG. 1. For example, the aircraft may be for commercial or military purposes, may be for transporting passengers or cargo, may have jet, propeller or other engine propulsion systems, may have a variety of fuselage/wing configurations, e.g. a high wing, low wing, or blended wing body, and may be designed to fly at subsonic, transonic or supersonic speeds. Although the present invention is described by reference to a wing, it will be understood that the present invention may be applicable to other aerofoil shaped bodies, such a tail planes.

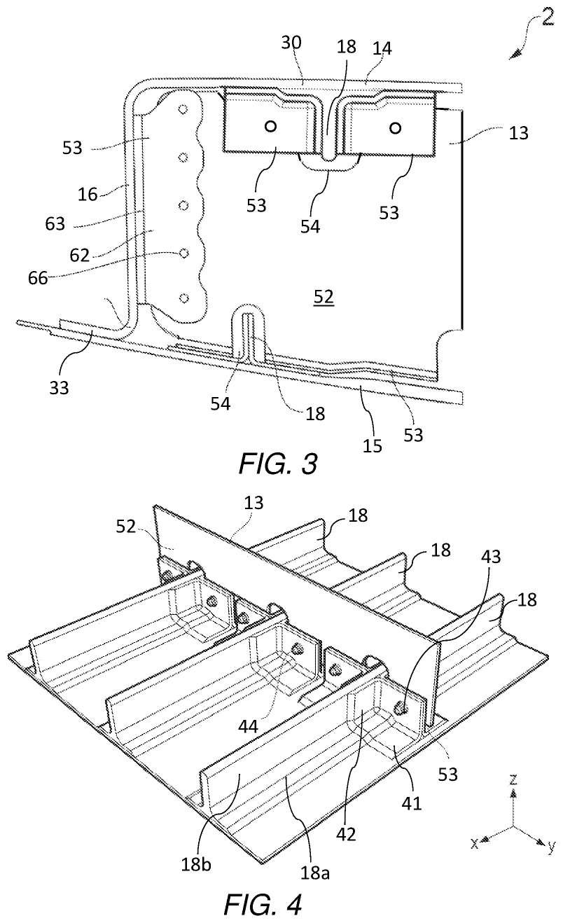

Each wing 2, 3 is formed as an aerofoil shaped body. Each wing has a cantilevered structure with a length extending in a spanwise direction from a root to a tip, the root being joined to an aircraft fuselage 4. Similarly, the horizontal and vertical tail planes 6, 7 are similarly arranged. Each wing 2, 3 includes a torsion box, otherwise known as a wing box. The wings 2, 3 are similar in construction so only the starboard wing 2 will be described in detail with reference to FIGS. 2 and 3.

The main structural element of the wing is a wing box formed by upper and lower covers 14, 15 and front and rear spars 16, 7. The covers 14, 15 and spars 16, 17 are each Carbon Fibre Reinforced Polymer (CFRP) laminate components. Each cover has an aerodynamic surface (the upper surface of the upper cover 14 and the lower surface of the lower cover 15) over which air flows during flight of the aircraft. Each cover also has an inner surface carrying a series of stringers 18 extending in the spanwise direction. Each cover carries a large number of stringers 18, only five of which are shown in FIG. 2 for purposes of clarity. Each stringer 8 is joined to one cover but not the other.

The wing box also has a plurality of transverse ribs, each rib being joined to the covers 14, 15 and the spars 16, 17. The ribs include an inner-most inboard rib 10 located at the root of the wing box, and a number of further ribs spaced apart from the inner-most rib along the length of the wing box. The wing box is divided into two fuel tanks: an inboard fuel tank bounded by the inboard rib 10, a mid-span rib 11, the covers 14, 15 and the spars 16, 17; and an outboard fuel tank bounded by the mid-span rib 11, an outboard rib 12 at the tip of the wing box, the covers 14, 15 and the spars 16, 17.

The inboard rib 10 is an attachment rib which forms the root of the wing box and is joined to a centre wing box 20 within the body of the fuselage 4. Baffle ribs 13 (shown in dashed lines) form internal baffles within the fuel tanks which divide the fuel tanks into bays. The ribs 10, 11, 12 are sealed to prevent the flow of fuel out of the two fuel tanks, but the baffle ribs 13 are not sealed so that fuel can flow across them between the bays. As can be seen in FIG. 2, the stringers 8 stop short of the inboard rib 10 and the outboard rib 12, but pass through the baffle ribs 13 and the mid-span rib 11.

FIG. 3 shows a cross sectional partial side view of a forward end region of the wing 2 of the aircraft 1. In the illustrated example, the wing 2 comprises a spar-cover 30 comprising the upper cover 14 and the front spar 16. However it will be appreciated that in other examples the spar and cover may be separate. The spar-cover 30 includes a lower spar flange 33. The spar-cover 30 is an integrally formed, monolithic component comprising the upper cover 14, the front spar 16, and the lower spar flange 33. The lower spar flange 33 acts as an attachment flange for mounting with the lower cover 15. The spar-cover 30 comprises fibre reinforced matrix composite laminate material, such as carbon fibre reinforced polymer. As can be seen from FIG. 3, the spar-cover 30 is substantially Z-shaped. The rear spar 17 (not shown in FIG. 3) may be substantially C-shaped with upper and lower attachment flanges for joining to the upper and lower covers 14, 15 respectively. In another arrangement, the spar-cover may be substantially Omega-shaped so as to comprise the one of the covers, and both the front and rear spars, with front and rear attachments flanges for joining to the other of the covers.

The rib 13 extends in a chordwise direction of the wing box. The rib configuration 13 extends between the front spar 16 and the rear spar 17, and between the upper cover 14 and lower cover 15. The rib 13 is joined to the front spar 16 by a rib post 60. The rib post 60 at the forward end attaches the rib 13 to the front spar 16. A corresponding rib post 60 at the rearward end of the rib 13 attaches the rib to the rear spar 17. One or more of the rib posts 60 may be integrally formed with the rib 13. The rib 13 comprises fibre reinforced matrix composite laminate material, such as carbon fibre reinforced polymer (CFRP). Although components are described herein as being formed from fibre reinforced matrix composite laminate material, such as carbon fibre reinforced polymer, it will be understood that alternative materials may be used.

The rib 13 includes a rib web 52. The rib web 52 defines the general plane of the rib 13. Rib feet 53 mount the rib 13 to the upper and lower covers 14, 15. The rib feet 53 adjacent the lower cover 15 are shown in FIG. 3 as integrally formed with the rib web 52. However, the rib feet 53 adjacent the upper cover 14 are shown in FIG. 3 as integrated with the upper cover 14 and the upper cover stringers 18, and are attached to the rib web 52, e.g. by bolting. The rib feet 53, stringers 18 and other components may be attached or co-cured to the upper and lower covers 14, 15 in various configurations.

The stringers 18 are of conventional type and so will not be described in further detail. The stringers 18 reinforce the covers, acting as spanwise extending reinforcing members, which are attached or integrally formed with the inside of the covers 14, 15. The stringers 18 extend through mouseholes 54 in the rib 13.

This invention particularly concerns the automated self-alignment of a robot during the joining of the rib web 52 to the rib post(s) 60 and the rib feet 53 during construction of the wing box.

The rib post 60 includes a rib post web 62 and a rib post foot 63. The rib post web 62 upstands from the rib post foot 63. The rib post foot 63 extends either side of the rib post web 62. The rib post 60 is substantially T-shaped, however it will be understood that alternative shapes are possible, for example L-shaped. The rib post web 62 extends transversely from the rib post foot 63. The rib post web 62 is fixedly mounted to the rib web 52. Fasteners 66 fix the rib post web 62 with the rib web 52. The fasteners 66 are conventional and may include rivets and/or bolts. The rib post web 62 overlaps the rib web 52 and is fixed in an overlapping arrangement.

FIG. 4 shows part of the upper cover 14 including three stringers 18. The rib 13 comprises a planar metallic web 52 connected to the upper cover by a plurality of CFRP laminate rib feet 53—six of such rib feet being shown in FIG. 4. Each rib foot 53 is formed by two mirror-symmetrical parts positioned back-to-back. Each part has a generally horizontal first flange 41; an upstanding second flange 42; and an upstanding web 43 positioned back-to-back with the web of the other part (these webs 43 being joined together back-to-back by a co-cured joint).

The first flange 41 of the rib foot is co-cured to the stringer flange 18a and inner surface of the cover 14. This co-cured joint (without bolts) between the rib foot flange 41 and the cover 14 means that no drilled bolt holes need to be provided in the cover. The second flange 42 is co-cured to the stringer web 18b, and the web 43 of the rib foot is joined to the rib web 52 by fasteners 44. The fasteners 44 are conventional and may include rivets and/or bolts. The rib foot web 43 overlaps the rib web 52 and is fixed in an overlapping arrangement.

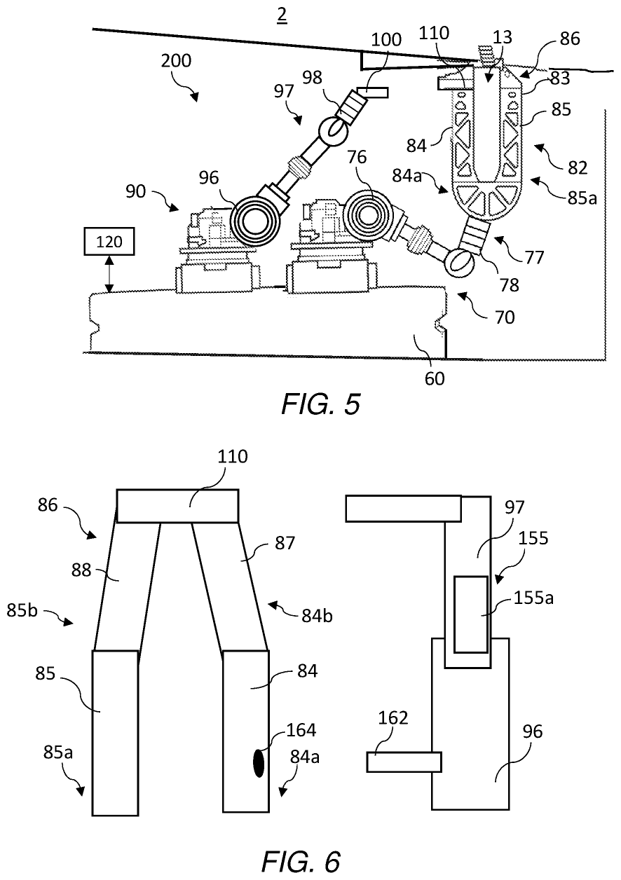

FIG. 5 shows a robot assembly with an automated self-aligning system 200 that is used for joining the rib web 52 to the integrated rib foot web 43 and/or the rib post web 62. The robot assembly includes a control system 120 connected to a first robot 70 and a second robot 90. In this example, the first and second robots 70, 90 are mounted on a common platform 60.

A clamping end effector 77 includes a clamping end effector connector 78 and a clamp 82. The clamping end effector connector 78 is attached to the clamp 82, which is generally U-shaped. A first robot arm 76 is coupled to the clamping end effector 77 by the clamping end effector connector 78, and the control system 120 controls the movement of the first robot arm 76 to position and orient the clamp 82 with respect to the wing box. The control system 120 (discussed further below) is electronically coupled to the first robot 70 and controls the functions of the clamp 82 through the end effector connector 78. The clamping end effector connector 78 therefore provides physical and electrical coupling to between the robot 70 and the clamp 82. The clamp 82 may be detachable from the end effector connector 78, or alternatively, may be permanently connected to the robot 70.

The clamp 82 has a frame 83 with a first arm 84 and a second arm 85. The clamp 82 has clamp jaws 86 for clamping on either side of a workpiece. The clamp jaws 86 includes a first jaw 87 at a distal end 84b of the first arm 84, and a second jaw 88 at a distal end 85b of the second arm 85. As shown, the arms 84, 85 are generally parallel and are attached at a proximal end of the arms 84a, 85a to form a generally U shape. The arms 84, 85 are distanced away to provide enough distance around the workpiece, such as the rib foot 43 of the rib, during positioning of the clamp 82. The distance between the arms 84, 85 may be greater than the width of the workpiece to provide enough distance to account for manufacturing tolerances of the workpiece.

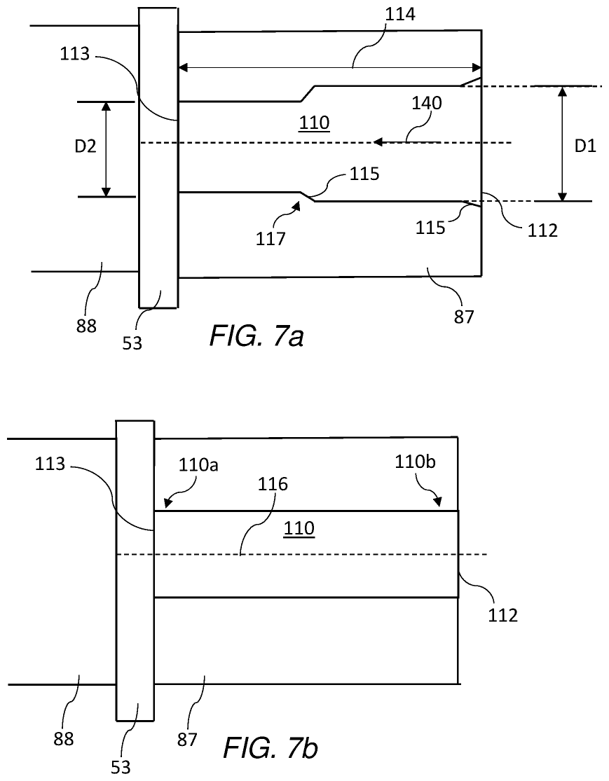

The first clamp jaw 87 is configured to receive a tool module 100 and has an aperture 110 (best shown schematically in FIGS. 7A and 7B). The aperture 110 has a forward end 110a and a rearward end 110b. The aperture 110 has a first opening 112 that extends to a second opening 113 and forms a through-hole. The first opening 112 is at a rearward end 110b of the aperture 110. The second opening 113 is at a forward end 110a of the aperture 110. As shown, the forward end 110a of the aperture 110 is adjacent to a workpiece clamped in between the jaws 87, 88. In this example, the workpiece is a region of the rib foot 53 that is arranged to be fastened to the rib web 52. However, the workpiece may be any component that is arranged to receive an operation from a tool module (discussed further below). For example. The workpiece may be a rib web and rib post, or an integrated rib foot.

The aperture 110 has a longitudinal length 114 which extends from the first opening 112 of the aperture 110 towards the second opening 113. The first opening 112 of the aperture 110 has a first diameter D1 and the second opening 113 has a second diameter D2. The aperture 110 has a longitudinal central axis 116. The longitudinal axis 116 extends along the longitudinal length 114 of the aperture and defines the centre of the aperture 110.

As shown in FIG. 7a, the first diameter D1 of the aperture 110 may reduce along the longitudinal length 114 towards the second diameter D2. In this example, the aperture 110 has a stepped portion 117 that reduces the diameter of the aperture 110. The diameter of the aperture 110 reduces stepwise along the longitudinal length 114 of the aperture in the direction of insertion 140. The stepwise reduction in diameter of the aperture 110 forms multiple concentric bores. In this example, the aperture 110 is formed from a first bore section 110c and a second bore section 110d.

The aperture 110 may have any number of stepped portions 117 along the length 114 to reduce the size of the aperture 110. The inner surface of the aperture 110 is shaped to accommodate the outer profile of the tool module 100 (which may be a drilling module with a drilling tool or a fastening module with a fastening tool). As shown, the stepped portions 117 includes a chamfer 115. Reducing the diameter of the aperture 100 towards the second opening 113 not only accommodates the tool module 100, but also helps guide the tool module 100 into the correct position relative to the clamped workpiece (discussed further below). This helps ensure that the tool module 100 is accurately positioned relative to the clamped workpiece.

Alternatively, as shown in FIG. 7b, the size of the first diameter D1 of the first opening 112 may be substantially similar to the size of the second diameter D2 of the second opening 113. The size of the aperture 110 therefore does not substantially change along the longitudinal length 114 of the aperture 110.

The aperture 110 is arranged to receive a tool module 100 through the first opening 112. For example, the aperture 110 may be configured to receive a collet of the tool module 100. The tool module 100 is moved along a direction of insertion 140 (discussed further below) by the second robot arm 96 to insert the tool module 100 into the aperture 110. To help the tool module 100 insert into the first opening 112, the first opening 112 may include a chamfer 115. When a longitudinal axis 106 of the tool module 100 is misaligned with the longitudinal axis 116 of the aperture, the chamfer 115 abuts against the tool module 100 as it moves along the direction of insertion 140. As shown, the chamfer 115 is angled towards the second opening 113 of the aperture 110.

A tooling end effector 97 includes the tool module 100 and a tooling end effector connector 98. The tooling end effector connector 98 is attached to the tool module 100. A second robot arm 96 is coupled to the second end effector connector 98, and the control system 120 controls the movement of the second robot 90 for positioning and orienting the tool module 100 for insertion into the clamp 82. The control system 120 is electronically coupled to the second robot 90 and controls the movement and orientation of the tool module via the second end effector connector 98. The second robot end effector connector 98 therefore provides physical and electrical coupling between the robot 90 and the tool module 100. The tool module 100 may be detatchable from the end effector connector 98, or alternatively, may be permanently connected to the robot 90.

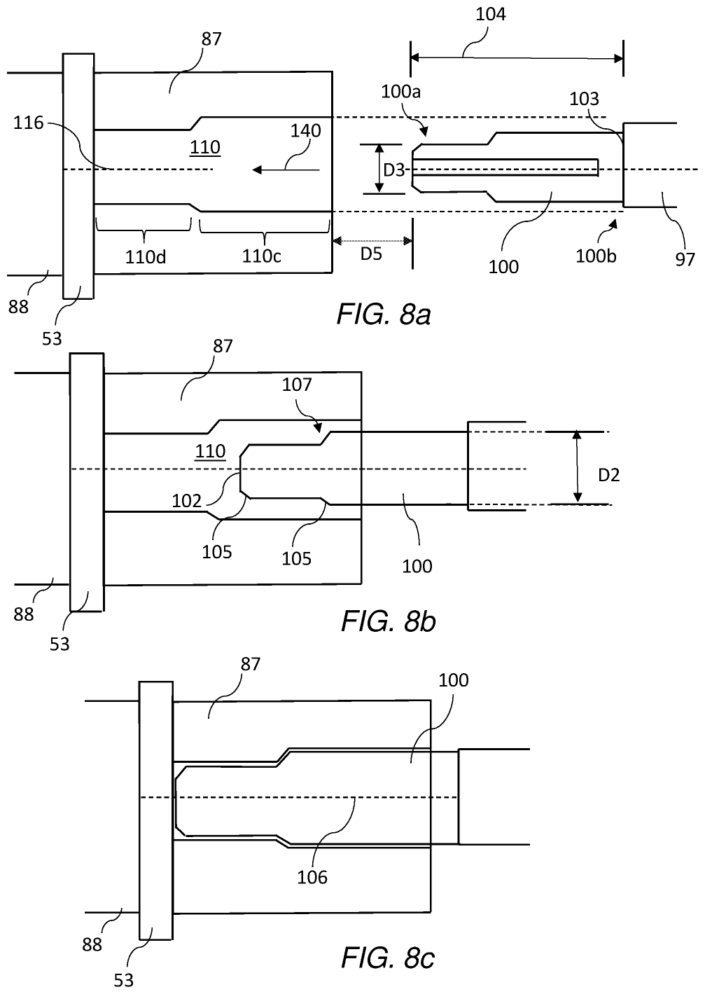

FIGS. 8A-8C schematically show an exemplary aperture 110 receiving a tool module 100. In this example, the tool module 100 is already substantially aligned with the aperture 110 and does not require any self-alignment during insertion. As shown, a forward end 100a of the tool module 100 is positioned near the opening 112 of the aperture 110 in FIG. 8a before being moved along a direction of insertion 140 towards the forward end 110a of the aperture 110 in FIG. 8b. The tool module 100 inserted into the aperture 110 in FIG. 8c. As shown, when the tool module 100 is inserted in the aperture 110, the forward end 100a of the tool module is adjacent the second opening of the aperture 113. The forward end 100a of the tool module 100 is therefore proximal to the workpiece 53.

The tool module 100 is arranged to carry a tool. When the tool module 100 is inserted into the aperture 110, the tool is adapted to perform an operation on the workpiece. The tool module 100 module may be one of a drilling module having a drilling tool, or a fastening module having a fastening tool. The fastening module may carry a fastener. The tool module 100 may have any suitable retention mechanism at the first end 102 of the tool module 100 to carry the tool.

The drilling tool may carry a drill bit. The drilling tool may be received by the aperture 110 in the first clamp jaw 87. The fastening tool may be received by the aperture 110 in the first clamp jaw 87 in a sequential operation.

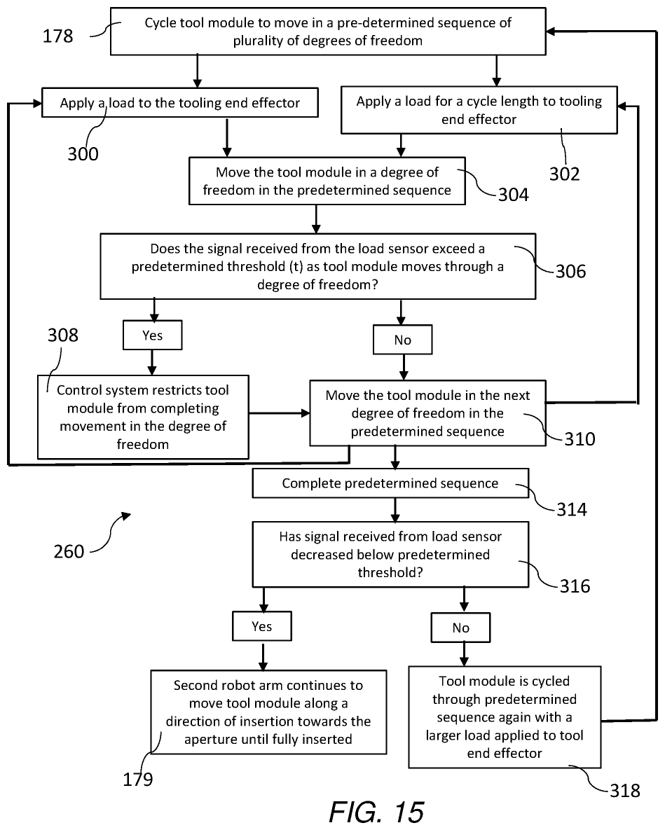

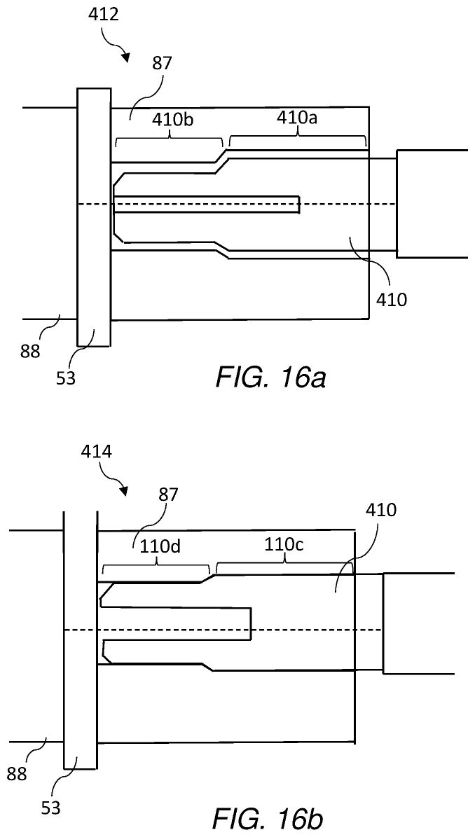

The tool module 100 may comprise an expanding collet 410, as shown in FIGS. 16a and 16b. The expanding collet 410 is in an undeployed state 412 in FIG. 15A and in a deployed state 414. In the deployed state 414, the expanding collet 410 is arranged to engage with the aperture 110.

In this example, the expanding collet 410 has a first portion 410a and a second portion 410b. The first and second portions 410a, 410b are concentric and the outer profile of the first and second portions generally conform to the inner surface of the aperture 110. When the collet 410 is in a deployed state 414, the first and second portions 410a and 410b engage with different concentric bore diameters 110c and 110d. The collet 410 engages with the bore diameters 110c, 110d by contacting the inner surface of the aperture 110. The collet 410 may be arranged to receive a tool. The expansion and contraction of the collet 410 may be operated automatically, e.g. by the first or second robots 70, 90 under instruction of the control system 120. Contracting the collet 410 may be used to securely grip and hold the tool module in the aperture.

The tool module has a first end 102 at a forward end 100a of the tool module 100, and a second end 103 at a rearward end 100b of the tool module 100. The second end 103 of the tool module 100 is arranged to be coupled to the tooling end effector connector 98. The tool module 100 has a central longitudinal axis 106. The longitudinal axis 106 extends along the longitudinal length 104 of the aperture. The longitudinal axis 106 defines the centre of the tool module 100.

The tool module 100 has a longitudinal length 104 that extends from the first end 102 to the second end 103. The first end 102 of the tool module 100 has a first end diameter D3. The second end 103 of the tool module 100 has a second end diameter D4. As shown in FIG. 8a, the first end diameter D3 may increase along the longitudinal length 104 towards the second end diameter D4.

In the example shown in FIGS. 8a-8c, the tool module 100 has one stepped portion 107 that also includes a chamfer 105. However, the tool module 100 may have any number of stepped portions 107. Generally, the number of stepped portions 107 and shape of the stepped portions corresponds with the number and shape of stepped portions 117 formed inside the aperture 110. The outer profile of the tool module 100 generally conforms with an inner surface of the aperture 110 so that there is minimal clearance between the tool module 100 and the aperture 110. This ensures that the tool module 100 may be accurately positioned relative to the workpiece when inserted into the aperture 110.

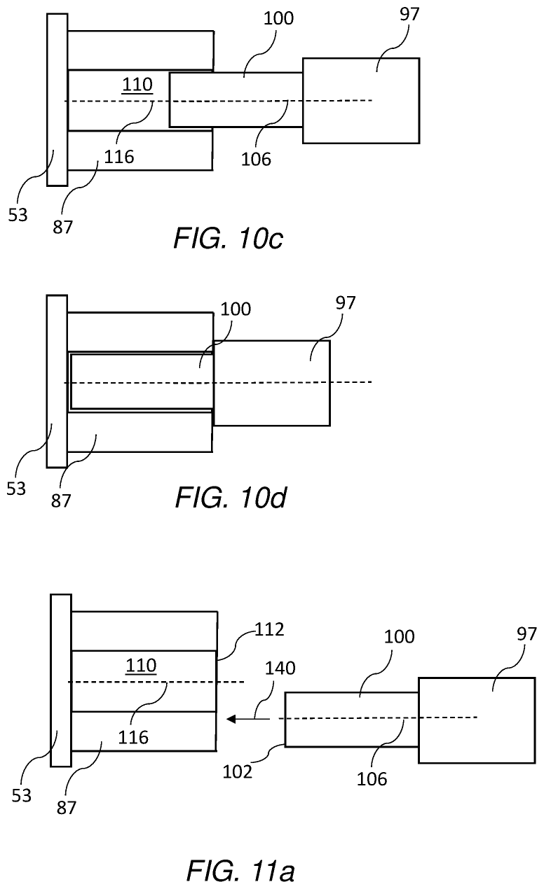

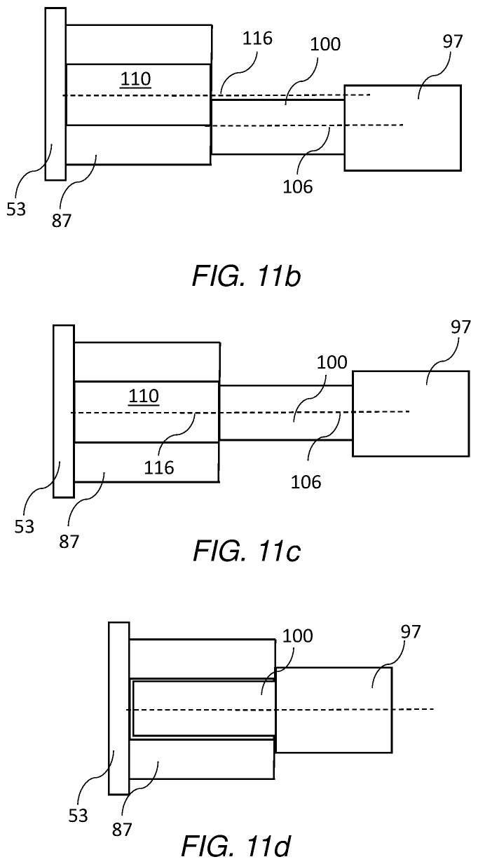

Alternatively, as shown in FIGS. 10a-10d and 11a-11d, the first end diameter D3 may be substantially similar to the second end diameter D4. The size of the tool module 100 therefore does not substantially change along the longitudinal length 104 of the tool module 100. In this example, the tool module 100 is substantially cylindrical.

The second robot arm 96 is arranged to move the tooling end effector 97. When the tooling end effector 97 is moved in a direction of insertion 140, the tool module 100 is also moved. The second robot arm 96 is arranged to move therefore arranged to move the tool module 100 in a direction of insertion 140 to insert the tool module 100 into the aperture 110. When the tool module 100 is moved in a direction of insertion 140, the forward end 100a of the tool module 100 is moved towards the forward end 110a of the aperture 110. The tooling end effector 97 is arranged to move the tool module 100 in a plurality of degrees of freedom 242 that is different than the direction of insertion 140 (discussed further below).

The first end 102 of the tool module 100 includes a chamfer 105. If the longitudinal axis 106 of the tool module 100 is misaligned with the longitudinal axis 116 of the aperture 110, the chamfer 105 abuts against the aperture 110 as the tool module 100 is moved along the direction of insertion 140.

As shown in FIGS. 8a-8c, the tool module 100 inserts into the aperture 110 without performing any self-alignment because the central axis 106 of the tool module 100 is substantially aligned with the central axis 116 of the aperture 110. The forward end 100a of the tool module is positioned proximal to the opening of the aperture 110 in FIG. 8a. In this example, the forward end 100a of the tool module 100 is positioned at a distance D5 from the opening of the aperture 112.

The control system 120 may use positional data of the tooling end effector 97 relative to the clamping end effector 77 to determine the direction of insertion 140. Alternatively, the control system 120 may use positional data of the tooling end effector 97 and the clamping end effector 77 relative to a global positioning reference to determine the direction of insertion 140. The positional data of the tooling and clamping end effectors 77, 97 may be determined by any suitable form of positional sensors.

The direction of insertion 140 may change depending on the positioning of the tooling end effector 97 relative to the clamping end effector 77. Preferably, the tool module 100 is moved along the direction of insertion 140 when the longitudinal axis 106 of the tooling module 100 with the longitudinal axis 116 of the aperture 110 are substantially aligned. This ensures that the tooling module 100 can insert into the aperture 110 without abutting against a nearby structure, such as the clamp jaw 87.

The tooling end effector 97 further comprises a drive system 155. The control system 120 and the tooling end effector 97 are coupled to a drive system 155. The drive system 155 includes a plurality of pressurised cylinders (155a, shown in FIG. 6) that are mounted onto, or otherwise physically coupled to the tooling end effector 97. Preferably, the pressurised cylinders 155a are pneumatic, but may alternatively be hydraulic.

The drive system 155 is arranged to exert a pressure or a load onto the tooling end effector 97 so that the tool module 100 may be moved with respect to the second robot arm 96. The second robot arm 96 therefore remains stationary as the tooling end effector 97 moves the tool module 100 in the plurality of degrees of freedom 242. The control system 120 moves the tooling end effector 97 through fine movements 280 with the drive system 155. The fine movements 280 of the tooling end effector 97 include movements in the plurality of degrees of freedom 242. As described below, the plurality of degrees of freedom 242 includes translations and rotations of the tooling end effector 97 and/or tool module 100 that are relatively small on a global positioning reference and/or in relative position to the second robot arm 96.

As shown in FIG. 8b, during insertion, the first end 102 of the tool module inserts the aperture 100 through the opening 112. In this example, it is easier for the first end 102 of the tool module 100 to insert into the aperture 110 because the opening 112 of the aperture 110 is generally larger than the first end 102 of the tool module 100.

The second robot arm 96 moves the tool module 100 in the direction of insertion 140 to insert the tool module 100 into the aperture 110 in FIGS. 8b and 8c. The second robot arm 96 only needs to be moved a small distance to insert the tool module 100 into the aperture 110.

The tooling end effector 97 and the clamping end effector 77 may include engageable alignment features 160 which may be engaged used to align the tooling end effector 97 and the clamping end effector 77. Aligning the tooling end effector 97 with the clamping end effector 77 ensures that the tooling end effector 97 and the clamping end effector 77 are aligned. The control system 120 may align the tooling end effector 97 and the clamping end effector 77 so the tool module 100 is at a distance D5 from the clamp jaw 87.

As shown in FIG. 6, the engageable alignment features 160 includes a protrusion 162 that extends from the tooling end effector 97. The protrusion 162 in this example is a pin 162 that is arranged to be received by an opening 164 on the clamping end effector 77. When the pin 162 is received in the opening 164, the tool module 100 is aligned with the clamping end effector 77. The tool module 100 may then be moved in the direction of insertion 140 to insert the tool module 100 into the aperture 110.

In other examples, the protrusion 162 may be arranged on the clamping end effector 77 while the opening 164 may on the tooling end effector 97. It will be understood that any suitable arrangement of engageable features 160 may be positioned on the tooling/clamping end effectors 97, 77. The engageable alignment features 160 may be any suitable mutually cooperating features positioned on the clamping end effector 77 and the tooling end effector 97.

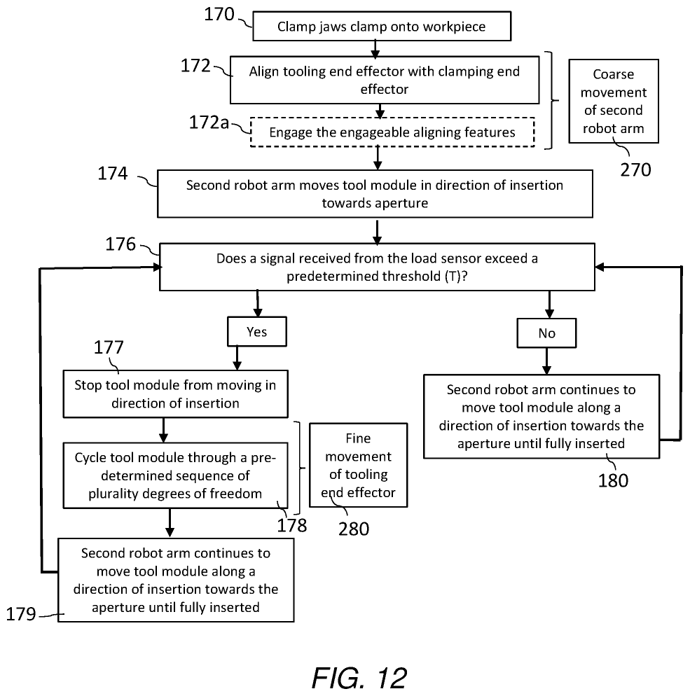

As shown in FIG. 12, the first robot arm 76 is moved first to position the clamping end effector 77 before securing the clamp 82 on the workpiece at step 170. Then, the control system 120 may move the second robot arm 96 to align the tool end effector 97 with the clamp end effector 77 in step 172.

The control system 120 may align the tooling end effector 97 using the engageable aligning features (as shown in step 172a) The second robot arm 96 moves the tool end effector 97 to engage the engageable aligning features 160.

In both examples, the second robot arm 96 and tooling end effector 97 completes coarse movements 270 relative to the first robot arm 76. Coarse movements 270 include large movements of the second robot arm 96 relative to the global positioning of the first robot arm 76 and/or the clamping end effector 77. The coarse movements 270 of the second robot arm 96 move the tooling end effector connector 98 closer to the tooling end effector connector 78.

As shown in FIG. 12, after the tooling end effector 97 is aligned with the clamping end effector 77, the second robot arm 96 moves the tool module 100 in the direction of insertion 140 towards the aperture 110 in step 174.

Preferably, aligning the tooling end effector 97 with the clamping end effector 77 also substantially aligns the longitudinal axis 106 of the tool module 100 with the longitudinal axis 116 of the aperture 110. However, the longitudinal axis 116 of the tool module 100 may be misaligned with the longitudinal axis 106 of the aperture 106 after the alignment stages 172, 172a.

The tool module 100 may be misaligned because of errors in the control system 120 so that the position or movement of the first and second robot arms 76, 96 is incorrect. The position of the tool module 100 may be altered, for example, because of the weight of the first robot 70 and the second robot 90 on the common platform 60. The weight of the robots 70, 90 may cause the common platform 60 to deform over time and alter the position of each robot arm 76, 96 in a global position reference. The control system 120 therefore determines the position of the arms 76, 96 to be in a different position than the actual position of the arms 76, 96.

Minor misalignments between the first and second robot arms 76, 96 affect the insertion of the tool module 100 intro the aperture 110. This is because the clearance between the outer profile of the tool module 100 and the inner surface of the aperture 110 is small to ensure that the tool module 100 is positioned accurately relative to the workpiece.

When the tool module 100 is misaligned with the aperture 110 and the second robot arm 96 moves along the insertion direction 140, the tool module 100 is unable to insert into the aperture 110 as shown in FIGS. 10a, 10b, 11a and 11b. In FIGS. 10a and 10b, the tool module 100 partially enters the aperture 110 before being unable move any further towards the forward end 110a of the aperture. In FIGS. 11a and 11b, the tool module 100 abuts against the clamp jaw 87 and is unable to enter the aperture 110.

In FIG. 10a, the first end 102 of the tool module 100 is angularly offset from the opening 112 of the aperture 110. The first end 102 of the tool module 100 is not parallel with the opening 112 of the aperture 110. In this example, the direction of insertion 140 is in line with the longitudinal axis 106 of the tool module 100. As the tool module 100 is moved in a direction of insertion 140 towards the aperture 110, the forward end 110a of the tool module 100 inserts into the opening 112 but abuts against the inner surface of the aperture 110. The tool module 100 is therefore restricted from further entering the aperture 100 along the direction of insertion 140.

In FIG. 11a, the first end 102 of the tool module 100 is parallel with the opening 112 of the aperture 110. However, the central axis 106 of the tool module 100 is offset from the central axis 116 of the aperture 110. In this example, the direction of insertion 140 is in line with the longitudinal axis 106 of the tool module 100. As the tool module 100 is moved in a direction of insertion 140 towards the aperture 110, the first end 102 abuts against a surface of the clamp jaw 87 but is unable to insert into the aperture 110. The tool module 100 is therefore restricted from entering the aperture 100 along the direction of insertion 140.

The tool module 100 abuts against a surface as the second robot arm 96 moves the tool module 100 along the direction of insertion 140 in both of the examples shown in FIGS. 10a and 11a. The tool module 100 is restricted from moving along the direction of insertion 140 because of a load applied to the tool module in the direction of insertion 140. The load generated in the direction of insertion 140 may therefore be utilised by the control system 120 as an indicator that the tool module 100 is stuck and unable to insert into the aperture 110.

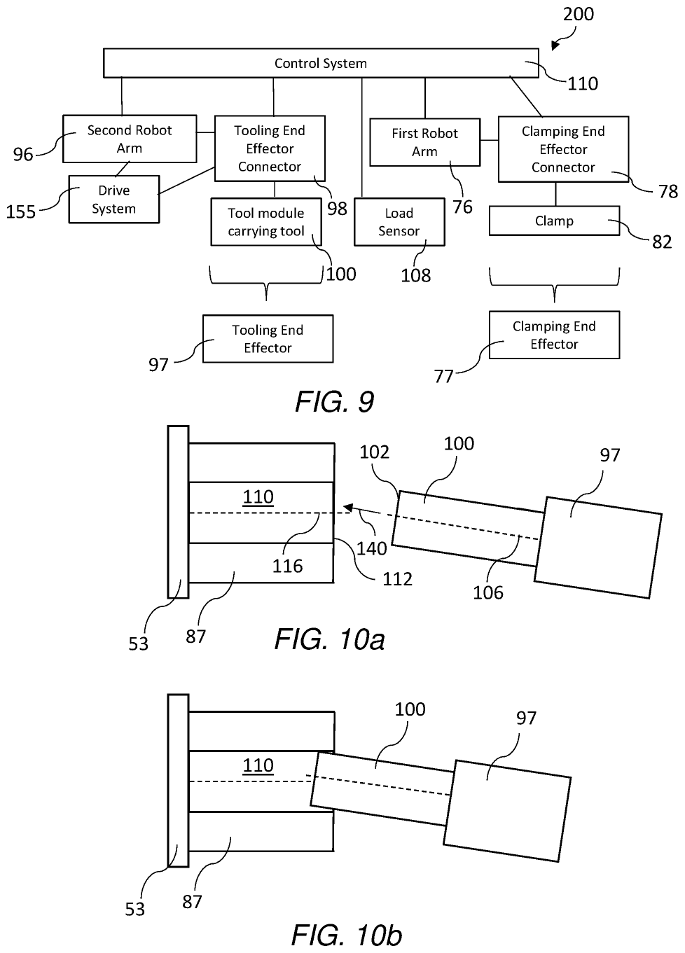

The second robot arm 96 includes a load sensor 108, as shown in FIG. 9 which schematically shows the automated self-aligning system 200. The load sensor 108 may be arranged on any part of the second robot arm 96. The load sensor 108 may be coupled to the tooling end effector 97. Alternatively, the load sensor 108 may be arranged in the tooling end effector connector 98, or at any position along the longitudinal length 104 of the tool module 100. The control system 120 is electronically coupled to the load sensor 108 through the tooling end effector connector 97.

The load sensor 108 arranged to determine a load in the direction of insertion 140 of the tool module 100. The load sensor 108 sends a signal to the control system 120 if the tool module 100 abuts against a structure (such as the clamp 82, the clamp jaws 86, or an inner surface of the aperture 110) as the tool module 100 moves along the direction of insertion 140. The load sensor 108 may be any suitable force sensor, such as a torque force sensor or a strain gauge.

The tool module 100 may generate some load in the direction of insertion 140 if the tool module touches, for example, the inner surface of the aperture 110 as the tool module 100 moves along the direction of insertion 140. The control system 120 is arranged to determine if the load exceeds a predetermined threshold, T.

The pre-determined threshold T indicates an amount of load that would be generated if the tool module 100 is “stuck”, i.e. unable to insert into the aperture 110. The predetermined threshold T may be pre-programmed into the control system 120 or may be determined from experimental data.

The predetermined threshold T may be different for different configurations of the tool module, e.g. the fastening tool module may have a higher threshold T than the drilling tool module. The predetermined threshold T may be adjusted depending on the tool module 100 or the application of the tool module 100 and aperture 110. The predetermined threshold T may also be determined depending on the speed that the tool module 100 moves along the direction of insertion 140.

When the load determined by the load sensor 108 exceeds the predetermined threshold T, the control unit 120 stops the tool module 100 from moving further along the insertion direction 140 before cycling through an automated self-aligning cycle in step 178 in FIG. 12 (discussed further below).

The first robot arm 76, the second robot arm 96, the tooling end effector 97, the clamping end effector 77, the drive system 155, the load sensor 108 and the control system 120 form the automated self-aligning system 200, as shown in FIG. 9. The automated self-aligning system 200 is arranged to self-align the tool module 100 as the tool module 100 moves along the direction of insertion 140 and when the tool module 100 is not substantially aligned with the central aperture 110.

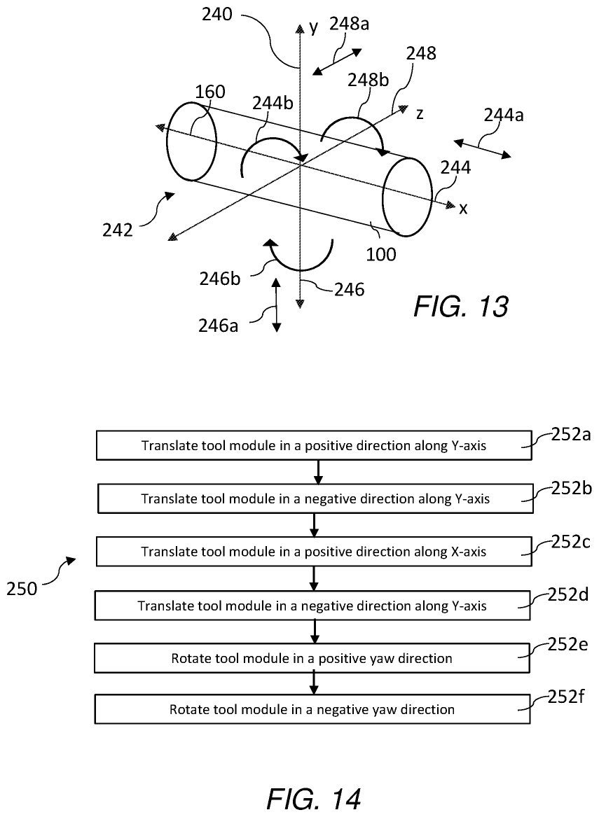

The self-aligning system 200 self-centres the tool module 100 with the central aperture 110. The method inserting the tool module 100 into the aperture 110 with the automated self-aligning of the tool module 100 will now be described in reference to FIG. 13. In this example, the clamp 82 is used to clamp the rib web to the overlapping integrated rib web foot, and the tool module 100 is used to automatically drill and fasten to the rib web to the rib foot web with a fastener.

At step 170, the first robot 76 is moved by the control system 120 to position and clamp the clamp jaws 86 of the clamp 82 in the correct position on the workpiece. At step 172, the control system 120 moves the second robot arm 96 to align the tooling end effector 97 and the clamping end effector 77. As shown in FIG. 12, this involves coarse movement 270 of the second robot arm 96. As shown in step 172a, aligning the tooling end effector 97 with the clamping end effector 77 optionally involves engaging engageable aligning features 160.

At step 174, the tool module 100 is moved along a direction of insertion 140 by the second robot arm 96 to begin inserting the tool module 100 into the aperture 110. Typically, the direction of insertion 140 is in line with the longitudinal axis 116 of the tool module 100. However, the direction of insertion 140 may be any suitable direction.

If the tool module 100 abuts against a surface while moving in the direction of insertion 140, the load sensor 108 generates a signal. If no signal is received, the control system 120 proceeds to step 180. The second robot arm 96 continues to move the tool module 100 along the direction of insertion 140 until the tool module 100 is inserted into the aperture 110.

If the load sensor 108 does generate a signal, the control system 120 determines if the signal exceeds the predetermined threshold T at step 176. If the signal does not exceed the predetermined threshold T, the control system 120 proceeds to step 180 to insert the tool module 100 into the aperture 110.

If the signal received from the load sensor 108 does exceed the predetermined threshold T at step 176, the control system 120 stops the tool module 100 from moving along the direction of insertion 140 at step 177. The control system 140 then uses the drive system 155 at step 178 to cycle the tool module 100 through a pre-determined sequence of a plurality of degrees of freedom 242.

FIG. 13 schematically shows the plurality of degrees of freedom 242 for the tool module 100. The control system 120 may use the tool module 100 to form a reference axis 240 to determine the plurality of degrees of freedom 242. Alternatively, the control system 120 may determine the reference axis 240 based on the global positioning of the second robot arm 96, the tooling end effector 97 and/or the tool module 100.

In this example, the longitudinal axis 106 of the tool module 100 coincides with the X-axis of the plurality of degrees of freedom 242. In other examples, the longitudinal axis 106 of the tool module 100 may be at any position relative to the X, Y and Z-axis of the reference axis 240. The tooling end effector 97 is arranged to move the tool module 100 through the plurality of degrees of freedom 242 with respect to the direction of insertion 140. The plurality of degrees of freedom 242 are different than the insertion direction 140.

The control system 120 uses the drive system 155 to move the tooling end effector 97 in the plurality of degree of freedom 242. The plurality of degrees of freedom 242 may include any translation with reference to the direction of insertion 140, such as positive and negative translation 244a of the tool module 100 along the X axis 244, positive and negative translation 246a of the tool module 100 along the Y axis 246 and positive and negative translation 248a of the tool module 100 along the Z axis 248. The plurality of degrees of freedom 242 may include any combination of translations thereof.

The plurality of degrees of freedom 242 may include any rotation around an axis with respect to the direction of insertion 140, such as positive and negative roll 244b of the tool module around the X axis 244, positive and negative yaw 246b of the tool module 100 along the Y axis 246 and positive and negative pitch 248b of the tool module 100 along the Z axis 248. The plurality of degrees of freedom 242 may include any combination of rotations thereof. The plurality of degrees of freedom 242 may include any combination of translations and rotations thereof.

The translation and rotation of the tool module 100 is small relative to the global positioning of the tool module 100. However, it will be understood that the tool module 100 is arranged to move orthogonally in two directions with respect to the direction of insertion 140 with respect to a global positioning or datum of the first and second robots 70, 90. As the clearance between the outer profile of the tool module 100 and the inner surface of the aperture 110 is minimal, the tool module 100 only needs to be moved through a small range of motion to find an unrestricted degree of freedom.

The control system 120 is arranged to cycle the tool module 100 to move in the plurality of degrees of freedom 242 in a predetermined sequence 250. The control system 120 is arranged to cycle the tool module 100 to align the tool module 100 with the aperture 110. Preferably, cycling the tool module 100 substantially aligns a longitudinal axis 106 of the tool module with a longitudinal axis 116 of the aperture 110.

An exemplary predetermined sequence 250 is shown in FIG. 14. In this example, the predetermined sequence 250 includes six separate movements 252 (labelled 252a-252f) in one of the plurality of degrees of freedom 242 for the tool module 100 to complete. The control system 120 uses the drive system 155 to act on the tooling end effector 97 to move the tool module 100 sequentially through each movement 252a-252f. Cycling the tool module 100 involves moving sequentially through each movement 252a-252f. While the exemplary predetermined sequence 250 includes six exemplary movements 252, it will be understood that the predetermined sequence 250 may have any number and combination of movements. Preferably, the predetermined sequence 250 includes at least 2 exemplary movements 252.

The control system 120 completes the movements in the predetermined sequence 250 at step 178 by using the drive system 155. At step 178, the control system 120 may use instructions 260 (shown in FIG. 15) to cycle the tool module 100 through the predetermined sequence 250. The instructions 260 helps to prevent damaging the tool module 100 and to ensure that the tool module 100 is free to move in the direction of insertion 140 after step 178 has been completed.

The control system 120 moves the tool module 100 in the plurality of degrees of freedom 242 by using the drive system 155 to apply a load to the tooling end effector 97. The drive system 155 may apply a load at a set value on the tooling end effector 97 at step 300. The drive system 155 may alternatively apply a load to the tooling end effector 97 at a set value for a cycle length at step 302. The cycle length may be any suitable period of time, such as 1 to 5 seconds. The cycle length may differ depending on the degree of freedom that the tool module 100 is moving through or may be the same length for each degree of freedom 242. The cycle length may be pre-programmed into the control system 120.

Steps 300 and 302 move the tool module 100 in a degree of freedom 242 in the predetermined sequence 250 at step 304. The load sensor 108 may continue to send signals to the control system 120 as the tool module 100 is moved in one degree of freedom in step 304. The control system 120 determines whether or not the signal received from the load sensor 108 exceeds a predetermined threshold t at step 306. The predetermined threshold t may be the same value as the predetermined threshold T in step 176 or may be a separate predetermined threshold.

If the signal received from the load sensor 108 exceeds the predetermined threshold t, the tool module 100 may be restricted from moving in the chosen degree of freedom 242 at step 308. Continuing the move the tool module 100 in the chosen degree of freedom 242 may risk damaging the tool module 100.

If the signal received from the load sensor 108 does not exceed the predetermined threshold t, then the tool module 100 completes the movement in the chosen degree of freedom 242 before moving on to the next degree of freedom 242 in the predetermined sequence 250 at step 310. The tool module 100 completes the movement in the degree of freedom 242 when the tool module 100 moves a set distance or through a rotation in response to the load applied to the tooling end effector 97 by the drive system 155.

The control system 120 completes moving the tool module 100 through each plurality of degree of freedom 242 in the predetermined sequence at step 310. As shown, the steps 300 to 310 are repeated until the predetermined sequence 250 is complete at step 314. Cycling the tool module 100 through the plurality of degrees of freedom 242 moves the first end 102 of the tool module 100 away from abutting against a surface.

At step 316, the control system 120 receives the signal from the load sensor 108 and determines if the signal has decreased below the predetermined threshold T. If the signal received from the load sensor 108 at step 316 has not decreased below the predetermined threshold T, the control system 120 repeats cycling the tool module 100 at step 178 but uses a larger load on the tooling end effector 97 to help free the first end 102 of the tool module 100.

If the signal has decreased below the predetermined threshold T, the control system 120 moves on to step 179 and the second robot arm 96 attempts to move the tool module 100 in the direction of insertion 140 to continue inserting the tool module 100 into the aperture 110.

If the tool module 100 is inside the aperture 110 (as shown in FIG. 10b), cycling the tool module 100 through the plurality of degrees of freedom 242 helps align the longitudinal axis 106 of the tool module with the longitudinal axis 116 of the aperture because the tool module 100 may only move within the aperture 110. As there is minimal clearance between the inner surface of the aperture 110 and the outer profile of the tool module 100, cycling through each degree of freedom 242 helps to iteratively align the tool module 100 in the aperture 110.

If the tool module 100 has a chamfer 105, then as the tool module 100 cycles through the plurality of degrees of freedom 242, the load determined by the load sensor 108 decreases along the length of the chamfer 105 towards the second opening 113 of the aperture 110. The chamfer 105 may therefore help guide the tool module 100 into the aperture 110 by indicating which direction or movement decreases the load by the load sensor 108. The direction that decreases the load sensed by the sensor 108 typically indicates the direction that helps substantially align the longitudinal axis 106 of the tool module 100 with the longitudinal axis 116 of the aperture 110.

If the tool module 100 is outside the aperture 110 (as shown in FIG. 11b), cycling the tool module 100 through the plurality of degrees of freedom 242 helps moves the first end 102 of the tool module 100 closer to the opening of the aperture 112. In this instance, cycling the tool module 100 at step 178 helps insert the first end 102 of the tool module 100 into the aperture 110.

In this example, if the opening 112 has a chamfer 115, then as the tool module 100 cycles through the plurality of degrees of freedom 242, the load the load sensor 108 decreases along the length of the chamfer 115 towards the second opening 113 of the aperture 110.

The chamfer 115 may therefore help guide the tool module 100 into the aperture 110 by indicating which direction or movement decreases the load by the load sensor 108. The direction that decreases the load sensed by the sensor 108 typically indicates the direction that helps substantially align the longitudinal axis 106 of the tool module 100 with the longitudinal axis 116 of the aperture 110. The chamfer 115 may also abut against the tool module 100 when the tool module moves in one of the plurality of degrees of freedom 242.

The self-alignment system 200 therefore automatically aligns the tool module 100 with the aperture 110 as the tool module 100 is moved along the direction of insertion 140. Cycling the tool module 100 at step 178 mimics the natural movement that a manual operator may use to try and free or align the tool module 100 in the aperture 110 so that it can continue along the direction of insertion 140.

FIGS. 10c, 10d, 11c and 11d show the tool module 100 after it has completed the self-alignment cycle step 78. As shown, the tool module 100 is aligned with the aperture 110 after the tool module 100 completed the self-alignment step 178. The first end 102 of the tool module 100 does not abut against an inner surface of the aperture 110 as the tool module 100 is moved along the insertion direction 140.

Once the tool module 100 is fully inserted in the aperture 110, the expansion and contraction of the collet of the tool module 100 secures the tool module 100 in the aperture 110. This may be operated automatically by the second robot 90 under the instruction of the control system 120.

After the clamp jaws 86 are clamped on the workpiece, the tool module 100 may perform an operation on the workpiece. For example, using a drilling tool of the tool module 100, the second robot 90 drills a fastener hole through the clamped rib web and overlapping integrated rib foot web. The drill bit (not shown) of the drilling tool passes through the aperture 110 in the first clamp jaw 87 to drill into the clamped components.

Once drilling of the fastener hole has completed the clamping load on the components is sustained. The second robot 90 then exchanges the drilling tool for a fastening tool. Once the second robot arm 96 has docked the fastening tool with the aperture 110 of the first clamp jaw 86, a fastener 44 may be installed in the fastener hole previously drilled in the clamped components. Installing the fastener 44 in the hole with the fastening module to fasten the clamped rib web and integrated rib foot web is completed prior to removing the clamping load. The fastener may be configured to pass through the aperture 110 in the first clamp jaw 87 to be installed in the clamped components. The fastener may be a single sided fastener, i.e. the fastener is installed from one side of the clamped components only without requiring fastener tool access to the other side.

When the tool module 100 communicates to the control system 120 that the fastening operation has completed and the fastener has been installed to fasten the rib web 52 to the rib foot web 43, the control system 120 then directs the jaws 86 to open (at least partially) to remove the clamping load. The tool module 100 may be undocked from the clamp 82 and moved away from the completed fastener location by the second robot 90 under the control of the control system 120. The clamp 82 may be moved away from the completed fastener location by the first robot 70 under the control of the control system 120.

The sequence can then be repeated to install more fasteners until all of the required fasteners and are installed during assembly of the wing box. It will be appreciated that the sequence for clamping the rib web 52 to the rib post web 62, drilling and installing fasteners is very similar to the sequence described above.

In this example, the clamp 82 is used to clamp a rib web or rib post or integrated rib foot of an aircraft wing for automated drilling and/or fastening of the rib web to the rib post or integrated rib foot.

The above description relates to using a tool module 100 for drilling and fastening a rib web to the rib post web 62. However, it will be understood that it may be used for any suitable similar operation.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

1. An automated self-aligning system, the system comprising:
a first robot arm attached to a clamping end effector including clamp jaws for clamping either side of a workpiece, and with an aperture in one of the clamp jaws;
a second robot arm attached to a tooling end effector including a tool module carrying a tool, wherein the tool module is insertable into the aperture, and the tool is adapted to perform an operation on the workpiece,
wherein the second robot arm is arranged to move the tool module so as to move the tool module in a direction of insertion so as to insert the tool module into the aperture;
a load sensor coupled to the tooling end effector;
wherein the load sensor is arranged to determine a load in the direction of insertion of the tool module;
wherein the tooling end effector is further arranged to move the tool module with respect to the second robot arm in a plurality of degrees of freedom different than the insertion direction; and
a control system connected to the tooling end effector, wherein the control system is arranged to cycle the tool module to move in the plurality of degrees of freedom in a predetermined sequence if the signal received from the load sensor exceeds a predetermined threshold.

2. An automated self-aligning system according to claim 1, wherein the control system is arranged to cycle the tool module to move through each of the plurality of degrees of freedom for a cycle length, or until the signal received from the load sensor is less than the predetermined threshold value.

3. An automated self-aligning system according to claim 1, wherein the diameter of the aperture reduces stepwise along a longitudinal length of the aperture in the direction of insertion to form multiple concentric bores.

4. An automated self-aligning system according to claim 1, wherein the tool module has plurality of diameters, and
a diameter at a forward end of the tool module is smaller than a diameter at a rearward end of the tool module.

5. An automated self-aligning system according to claim 1, wherein the tool module comprises an expanding collet to engage with the aperture, preferably the tool module comprises multiple concentric expanding collets or collet portions of different diameters, wherein each expanding collet or collet portion engages with a different concentric bore diameter of the aperture.

6. An automated self-aligning system according to claim 1, wherein an opening of the aperture comprises at least one chamfer.

7. An automated self-aligning system of claim 1, wherein the tooling end effector further comprises a drive system, and wherein the drive system is arranged to move the tool module with respect to the second robot arm.

8. An automated self-aligning system according to claim 1, wherein the plurality of degrees of freedom includes at least two of: vertical translation, horizontal translation, rolling, pitching or yawing with respect to the direction of insertion.

9. An automated self-aligning system of claim 1, wherein system is further configured to align the clamping end effector relative to the tooling end effector using engageable aligning features, and optionally, wherein the engageable aligning features comprise a protrusion on one end effector that is arranged to be received in an opening of the other end effector.

10. An automated self-aligning system of claim 1, wherein the first robot arm is attached to a first robot and the second robot arm is attached to a second robot, wherein the first and second robots are mounted on a common platform.

11. An automated self-aligning system of claim 1, wherein the tool module is one of a drilling module for carrying a drilling tool, or a fastening module for carrying a fastener.

12. An automated self-aligning system of claim 1, wherein the workpiece is a rib web and rib post or integrated rib foot.

13. A method of automatically aligning a tool module carried by a tooling end effector into an aperture of a clamp jaw carried by a clamping end effector,
wherein a first robot arm is attached to the clamping end effector and a second robot arm is attached to the tooling end effector, the method comprising:
using the second robot arm to move the tool module so as to move the tool module along a direction of insertion to insert the tool module into the aperture;
receiving a signal from a load sensor coupled to the tooling end effector that exceeds a predetermined threshold; wherein the sensor is arranged to determine a load in the direction of insertion of the tool module;
cycling the tool module to move with respect to the second robot arm in a plurality of degrees of freedom in a predetermined sequence to align the tool module with the aperture, wherein the tool module is cycled until the signal from the load sensor is less than the predetermined threshold, wherein moving in the plurality of degrees of freedom is different than moving in the insertion direction.

14. A method of automatically aligning a tool module according to claim 13, wherein cycling the tool module substantially aligns a longitudinal axis of the tool module with a longitudinal axis of the aperture.

15. A method of automatically aligning a tool module according to claim 13, wherein after the tool module has cycled through all of the plurality of degrees of freedom, the second robot arm attempts to move the tool module in the direction of insertion to continue inserting the tool module into the aperture.

16. A method of automatically aligning a tool module according to claim 13, wherein the tool module is arranged to cycle through each plurality of degrees of freedom for a cycle length or until the signal received from the load sensor is below the predetermined threshold.

17. A method of automatically aligning a tool module according to claim 13, wherein the tooling end effector and the clamping end effector further comprise engageable aligning features, the method further comprising moving the second robot arm to engage the engageable aligning features.

18. A method of automatically aligning a tool module according to claim 13, wherein an opening of the aperture comprises a chamfer, the method further comprising abutting the chamfer against the tool module when the tool module is moved along the direction of insertion when a longitudinal axis of the tool module is misaligned with a longitudinal axis of the aperture.

19. A method of automatically aligning a tool module according to claim 13, wherein the tool module comprises at least one chamfer, the method further comprising abutting the at least one chamfer against the aperture when the tool module is moved along the direction of insertion or when the tool module is cycled to move in the plurality of degrees of freedom when a longitudinal axis of the tool module is misaligned with a longitudinal axis of the aperture.

20. A method of automatically aligning a tool module according to claim 13, wherein the tool module is a drilling module, the method further comprises closing the clamp jaws on the workpiece and drilling a hole with the drilling module through the workpiece.
